(19) United States
(12) Patent Application Publication
(10) Pub. No.: US 2009/0221347 A1
(43) Pub. Date: Sep. 3, 2009

(54) Slot Machine And Playing Method Thereof

(75) Inventor: Yukinori INAMURA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/116,521

(22) Filed: May 7, 2008

Related U.S. Application Data
(60) Provisional application No. 61/032,288, filed on Feb. 28, 2008.

(51) Int. Cl. A63F 9/24; A63F 13/00

(52) U.S. Cl. 463/20; 463/25

(57) ABSTRACT

A slot machine of the present invention is provided with: a display device on which plural types of symbols are arranged and a plurality of paylines can be set; at least one input device; and a controller. The controller is operable to: determine “n” paylines (n=1) from among the plurality of paylines, based upon input information input from the input device; set on the display device such determined “n” paylines; automatically rearrange the plural types of symbols arranged on the display device; count the number of symbols of a same type, the symbols being rearranged on such set “n” paylines; and award prizes corresponding to the number of symbols counted in such “n” paylines.

### CROSS-REFERENCE TO RELATED APPLICATIONS

This application claims priority of U.S. Provisional Application No. 61/032,288 filed on Feb. 28, 2008. The contents of this application are incorporated herein by reference in their entirety.

### FIELD OF THE INVENTION

The present invention relates to a slot machine and a playing method thereof, which allow players to enjoy slot games with the use of gaming media such as coins or bills.

### DESCRIPTION OF THE RELATED ART

In a conventional slot machine, if a player inserts gaming media such as coins or bills into an insertion slot and presses a spin button, a plurality of symbols are then displayed in a scrolling manner on a display device provided on the front surface of a casing, and thereafter, scrolling of the respective symbols is automatically stopped.

In such a slot machine, if a predetermined combination of symbols is displayed in a stopped state along a payline, a predetermined number of gaming media are then paid out, as disclosed in, for example, U.S. Pat. No. 6,604,999-B2 and US 2002-065124-A1. Regardless of the payline, further, a predetermined number of gaming media are paid out, corresponding to the number of specific symbols referred to as scatter symbols, which were displayed on the display device.

The present invention provides a slot machine and a playing method thereof, which can offer entertainability to players that has not been successfully attained by those of the aforementioned conventional art.

### SUMMARY OF THE INVENTION

A first aspect of the invention is a slot machine, including: a display device on which plural types of symbols are arranged and a plurality of paylines can be set; at least one input device; and a controller, the controller being configured to: (i) determine “n” paylines (n=1) from among the plurality of paylines, based upon input information input from the input device; (ii) set on the display device such “n” paylines determined in the itemized (i); (iii) automatically rearrange the plural types of symbols arranged on the display device; (iv) count the number of symbols of a same type, the symbols being rearranged on such “n” paylines set in the itemized (ii); and (v) award prizes corresponding to the number of symbols counted in the itemized (iv).

According to the first aspect of the present invention, “n” paylines (n=1) are determined from among a plurality of paylines, based upon input information input from an input device. Then, the determined payline is set on a display device. Further, plural types of symbols arranged on the display device is automatically rearranged, and the number of symbols of a same type, which were rearranged on the set “n” paylines, is counted. Furthermore, prizes are awarded corresponding to the counted number of symbols. Therefore, prizes are determined depending upon “n” paylines determined based upon the input information and the types and number of symbols. Thus, players are allowed to raise the feeling of expectation not only for the number of displayed symbols, but also a payline on which symbols are displayed. In this manner, a variety of enjoyments can be provided to the players.

A second aspect of the present invention is a slot machine constituted as set forth below. In the first aspect, the input device is for inputting a BET number; and the controller, in the itemized (i), counts the BET number input from the input device, and then, determines “n” paylines from among the plurality of paylines.

According to the second aspect of the present invention, BET number input from the input device is counted, and then, based upon the counted BET number, “n” paylines are determined from among a plurality of paylines. In this manner, the position of the payline can be set corresponding to the BET number, thus allowing the players to set at least any one payline.

A third aspect of the present invention is a slot machine constituted as set forth below. In the first aspect, when input information is input from the input device, the controller, in the itemized (i), determines “n” paylines from among the plurality of paylines, based upon the input information input from the input device.

According to the third aspect of the present invention, when input information is input from the input device, “n” paylines are determined, based upon the input information. In this manner, only when the input information is input from the input device, a payline is set on the display device. Thus, games corresponding to the presence or absence of the payline can be provided to the players.

A fourth aspect of the present invention is a slot machine constituted as set forth below. In the first aspect, the prizes of the itemized (v) include a first prize for executing a free game by a predetermined number of times and a second prize with high payment to be accumulatively added; and the controller, in the itemized (v), awards the first prize if the number of symbols counted in the itemized (iv) is a first number, awards the second prize if it is a second number, and awards both of the first and second prizes if it is a third number.

According to the fourth aspect of the present invention, the prizes include a first prize for executing a free game by predetermined number of times and a second prize with high payment to be accumulatively added. Then, the first prize is awarded if the counted number of symbols is a first number; the second prize is awarded if it is a second number; and both of the first and second prizes are awarded if it is a third number. Thus, types of prizes are different depending upon the number of symbols. In this manner, a variety of prizes can be provided to the players.

A fifth aspect of the present invention is a slot machine constituted as set forth below. In the first aspect, the controller further includes paying out gaming media corresponding to the number of symbols of a same type, the symbols being rearranged on such “n” paylines.

According to the fifth aspect of the present invention, gaming media are paid out corresponding to the number of symbols of a same type, the symbols being rearranged on such “n” paylines. In this manner, a variety of payments can be provided to the players.

A sixth aspect of the present invention is a slot machine constituted as set forth below. In the first aspect, the controller further includes paying out gaming media corresponding to the number of symbols, the symbols being rearranged in all regions of the display device including an area on such “n” paylines.

According to the sixth aspect of the present invention, gaming media are paid out corresponding to the number of symbols of a same type, the symbols being arranged in all regions of the display device including a region on such “n” paylines. Therefore, apart from prizes, the number of symbols of a same type is determined in all regions of the display device, and then, gaming media are paid out corresponding to the number of symbols. In this manner, a variety of payments can be provided to the players.

A seventh aspect of the present invention is a slot machine constituted as set forth below. In the first aspect, the input device is for inputting a BET number; and if a BET number is input from the input device, the controller counts the input BET number, and accumulatively adds to the prizes of the itemized (v) gaming values that are based upon the counted BET number.

According to the seventh aspect of the present invention, if BET number is input from the input device, the input BET number is counted, and then, gaming values based upon the counted BET number are accumulatively added to the prizes of (v). In this manner, the prizes are accumulatively added on a game-by-game basis, thus allowing the players to increase expectation for winning the prizes every increased number of times in executing games.

An eighth aspect of the present invention is a slot machine constituted as set forth below. In the first aspect, the prizes of the itemized (v) are payout of gaming media corresponding to the number of symbols of a same type; and the controller, in the itemized (v), pays out the gaming media corresponding to the number of symbols counted in the itemized (iv).

According to the eighth aspect of the present invention, the prizes are payout of gaming media according to the number of symbols of the same type, and gaming media are paid out corresponding to the counted number of symbols. In this manner, a variety of payments corresponding to the types and number of symbols can be provided to the players.

A ninth aspect of the present invention is a slot machine including a display device having a plurality of compartmented regions arranged in a matrix, plural types of symbols being disposed in each of the compartmented regions; at least one input device; and a controller, the controller being configured to: (i) determine a plurality of activated regions from among the plurality of compartmented regions, based upon input information input from the input device; (ii) set on the display device such plurality of activated regions determined in the itemized (i); (iii) automatically rearrange plural types of symbols in the plurality of compartmented regions; (iv) count the number of symbols of a same type, the symbols being rearranged in such plurality of activated regions set in the itemized (ii); and (v) award prizes corresponding to the number of symbols counted in the itemized (iv).

According to the ninth aspect of the present invention, a plurality of activated regions are determined from among columns of a plurality of compartmented regions, based upon input information input from an input device. Then, the determined plurality of activated regions are set on a display device. Further, plural types of symbols are automatically rearranged in a plurality of compartmented regions, and then, the number of symbols of a same type, the symbols being rearranged in the set the plurality of the activated regions, is counted. Prizes are awarded corresponding to the counted number of symbols. Therefore, the prizes are determined depending upon the plurality of activated regions determined based upon the input information and the types and number of symbols. Thus, the players are allowed to raise the feeling of expectation not only for the number of displayed symbols, but also for the plurality of activated regions in which symbols are displayed. In this manner, a variety of enjoyments can be provided to the players.

A tenth aspect of the present invention is a slot machine constituted as set forth below. In the ninth aspect, the input device is for inputting a BET number; and the controller, in the itemized (i), counts the BET number input from the input device, and then, determines the plurality of activated regions from among the plurality of compartmented regions, based upon the counted BET number.

According to the tenth aspect of the present invention, the BET number input from an input device is counted, and then, based upon the counted BET number, a plurality of activated regions are determined from among the plurality of compartmented regions. In this manner, the positions and number of activated regions can be set corresponding to the BET number, thus allowing the players to set at least any one payline.

An eleventh aspect of the present invention is a slot machine constituted as set forth below. In the ninth aspect, the controller further includes paying out gaming media corresponding to the number of symbols of a same type, the symbols being rearranged on the plurality of activated region.

According to the eleventh aspect of the present invention, gaming media are paid out corresponding to the symbols of a same type, the symbols being rearranged on a plurality of activated regions. In this manner, a variety of payments can be provided to the players.

A twelfth aspect of the present invention is a slot machine constituted as set forth below. In the ninth aspect, the controller further includes paying out gaming media corresponding to the number of symbols of a same type, the symbols being rearranged in all regions of the display device including the plurality of activated regions.

According to the twelfth aspect of the present invention, gaming media are paid out corresponding to the number of symbols of a same type, the symbols being rearranged in all regions of the display device including a plurality of activated regions. Apart from prizes, therefore, the number of symbols of the same type is determined in all regions of the display device, and then, gaming media are paid out corresponding to the determined number of symbols. In this manner, a variety of payments can be provided to the players.

A thirteenth aspect of the present invention is a slot machine playing method, including the steps of: (i) determining “n” paylines (n=1) from among the plurality of paylines, based upon input information input from the input device; (ii) setting on the display device such “n” paylines determined at the step (i); (iii) automatically rearranging the plural types of symbols arranged on the display device; (iv) counting the number of symbols of a same type, the symbols being rearranged on such “n” paylines set at the step (ii); and (v) awarding prizes corresponding to the number of symbols counted at the step (iv).

According to the thirteenth aspect of the present invention, based upon input information input from an input device, “n” paylines (n=1) are determined from among a plurality of paylines that can be set on a display device. Then, the determined payline is displayed on the display device. Further, plural types of symbols arranged on the display device are automatically rearranged, and the number of symbols of a same type, the symbols being rearranged on the set “n” paylines, is counted. Furthermore, prizes are awarded corresponding to the counted number of symbols. Therefore, the prizes are determined depending upon “n” paylines determined based upon input information and the types and number of symbols. Thus, the players are allowed to raise the feeling of expectation not only for the number of displayed symbols, but also for a payline on which symbols are displayed. In this manner, a variety of enjoyments can be provided to the players.

A fourteenth aspect of the present invention is a slot machine playing method constituted as set forth below. In the thirteenth aspect, a BET number is input from the input device; and the step (i) counts the BET number input from the input device is counted at the step (i), and “n” paylines are determined from among the plurality of paylines, based upon the counted BET number.

According to the fourteenth aspect of the present invention, BET number input from an input device is counted, and then, based upon the counted BET number, “n” paylines are determined from among the plurality of paylines. In this manner, the position of the payline can be set corresponding to the BET number, thus allowing the players to set at least any one payline.

A fifteenth aspect of the present invention is a slot machine playing method constituted as set forth below. In the thirteenth aspect, when input information is input from the input device, “n” paylines are determined from among the plurality of paylines, based upon the input information input from the input device at the step (i).

According to the fifteenth aspect of the present invention, when input information is input from an input device, “n” paylines are determined from among a plurality of paylines, based upon the input information. In this manner, only when the input information is input from the input device, “n” paylines are set on a display device. Thus, games corresponding to the presence or absence of the payline can be provided to the players.

A sixteenth aspect of the present invention is a slot machine playing method constituted as set forth below. In the thirteenth aspect, at the step (v), a first prize is awarded for executing a free game by a predetermined number of times if the number of symbols counted at the step (iv) is a first number; a second prize with high payment is awarded to be accumulatively added if it is a second number; and both of the first and second prizes are awarded if it is a third number.

According to the sixteenth aspect of the present invention, if the counted number of symbols is a first number, a first prize for executing a free game by a predetermined number of times is awarded; if it is a second number, a second prize with high payment is awarded; and if it is a third number, both of the first and second prizes are awarded. Thus, types of prizes are different depending upon the number of symbols. In this manner, a variety of prizes can be provided to the players.

A seventeenth aspect of the present invention is a slot machine playing method constituted as set forth below. In the thirteenth aspect, the playing method further includes the step of paying out gaming media corresponding to the number of symbols of a same type, the symbols being rearranged on such “n” paylines.

According to the seventh aspect of the present invention, gaming media are paid out corresponding to the number of symbols of a same type, the symbols being rearranged on “n” paylines. In this manner, a variety of payments can be provided to the players.

An eighteenth aspect of the present invention is a slot machine playing method constituted as set forth below. In the thirteenth aspect, the playing method further includes the step of paying out gaming media corresponding to the number of symbols of a same type, the symbols being rearranged in all regions of the display device including a region on such “n” paylines.

According to the eighteenth aspect of the present invention, gaming media are paid out corresponding to the number of symbols of a same type, the symbols being rearranged in all regions of the display device including “n” paylines. Apart from prizes, therefore, the number of symbols of the same type is determined in all regions of the display device, and then, gaming media are paid out corresponding to the determined number of symbols. In this manner, a variety of payments can be provided to the players.

A nineteenth aspect of the present invention is a slot machine playing method constituted as set forth below. In the thirteenth aspect, a BET number is inputted from the input device, and the playing method further includes the steps of: if a BET number is input from the input device, counting the input BET number; and accumulatively adding to the prizes of the step (v) the gaming values that are based upon the counted BET number.

According to the nineteenth aspect of the present invention, a BET number is input from an input device, the input BET number is counted, and then, gaming values based upon the counted BET number are accumulatively added to the prizes. In this manner, the prizes are accumulatively added on a game-by-game basis, thus allowing the players to increase the feeling of expectation for winning the prizes every increased number of times in executing games.

A twentieth aspect of the present invention is a slot machine playing method constituted as set forth below. In the thirteenth aspect, the prizes of the step (v) are payout of gaming media corresponding to the number of symbols of a same type, and gaming media corresponding to the number of symbols counted at the step (iv) are paid out at the step (v).

According to the twentieth aspect of the present invention, the prizes are payout of gaming media corresponding to the number of symbols of the same type, and gaming media are paid out corresponding to the counted number of symbols. In this manner, a variety of payments corresponding to the types and number of symbols can be provided to the players.

According to the present invention, prizes corresponding to “n” paylines determined based upon input information and the types and number of symbols can be provided. Thus, a slot machine and a playing method thereof can be provided which are capable of additionally offering new entertainability to players.

### BRIEF DESCRIPTION OF THE DRAWINGS

FIG. 1A is a view showing an exemplary display of symbols arranged on a display device;

FIG. 1B is a view showing an exemplary display of symbols arranged on the display device:

FIG. 2A is a view showing another display of symbols arranged on the display device;

FIG. 2B is a view showing another display of symbols arranged on the display device;

FIG. 3 is an explanatory view of a relationship between BET numbers and paylines;

FIG. 4 is an explanatory view of a relationship between BET numbers and display blocks;

FIG. 5 is an explanatory view of a special prize;

FIG. 6 is a perspective view showing an appearance of a slot machine;

FIG. 7 is an explanatory view of symbols, which are displayed by display block columns, and code Nos.;

FIG. 8 is a view for explaining a scatter prize;

FIG. 9 is a block diagram depicting an internal construction of the slot machine;

FIG. 10 is a flowchart showing a subroutine of game execution processing;

FIG. 11A is a view showing an exemplary display of symbols arranged on the display device;

FIG. 11B is a view showing an exemplary display of symbols arranged on the display device;

FIG. 12 is a flowchart showing a subroutine of symbol determination processing;

FIG. 13 is a flowchart showing a subroutine of future game processing;

FIG. 14A is a view showing an exemplary display of symbols arranged on the display device; and

FIG. 14B is a view showing an exemplary display of symbols arranged on the display device.

### DESCRIPTION OF THE PREFERRED EMBODIMENTS

Hereinafter, one embodiment of a slot machine and a playing method thereof, according to the present invention, will be described with referring to the drawings.

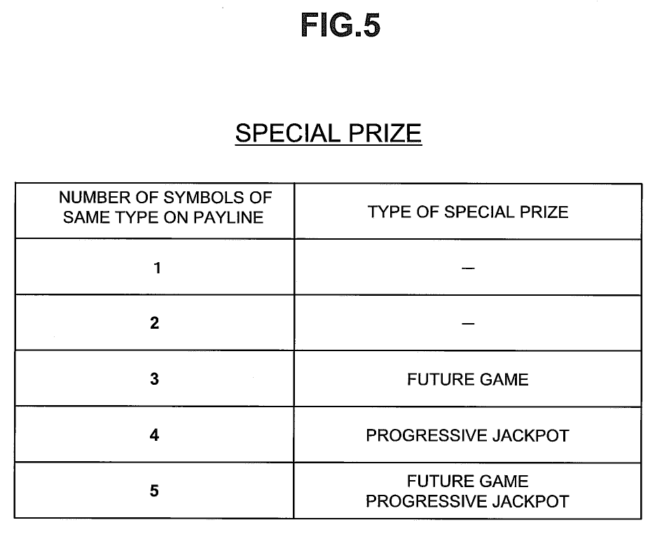

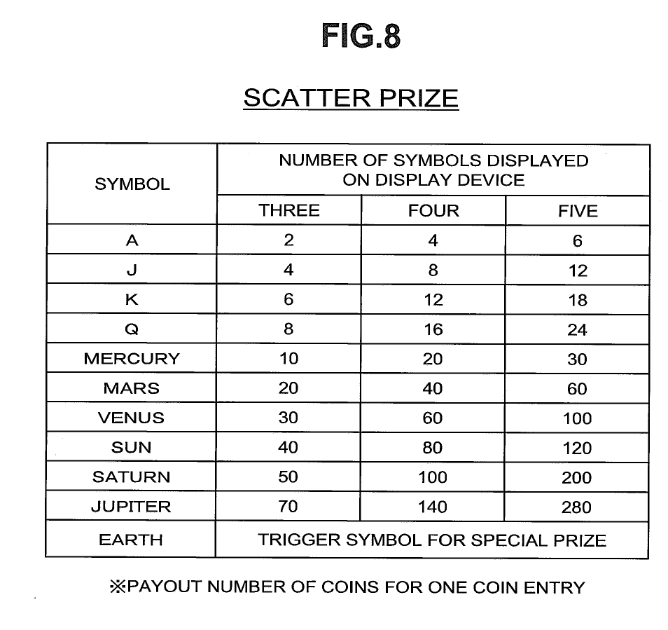

In the slot machine according to the present embodiment, from among a plurality of paylines L1 to L3, “n” paylines L (n=1) are activated based upon input information input from an input device. When plural types of scatter symbols are automatically rearranged, the scatter symbols of the same type, which were arranged on the activated payline L, are determined (counted) in number. As the result of determination, the number of scatter symbols of the same type is in a predetermined number or more, apart from payout of the predetermined number of coins based upon a scanner prize described later (refer to FIG. 8), a special prize (transition to a future game or payout due to a jackpot) according to the arranged scatter symbols is executed, as shown in FIG. 5.

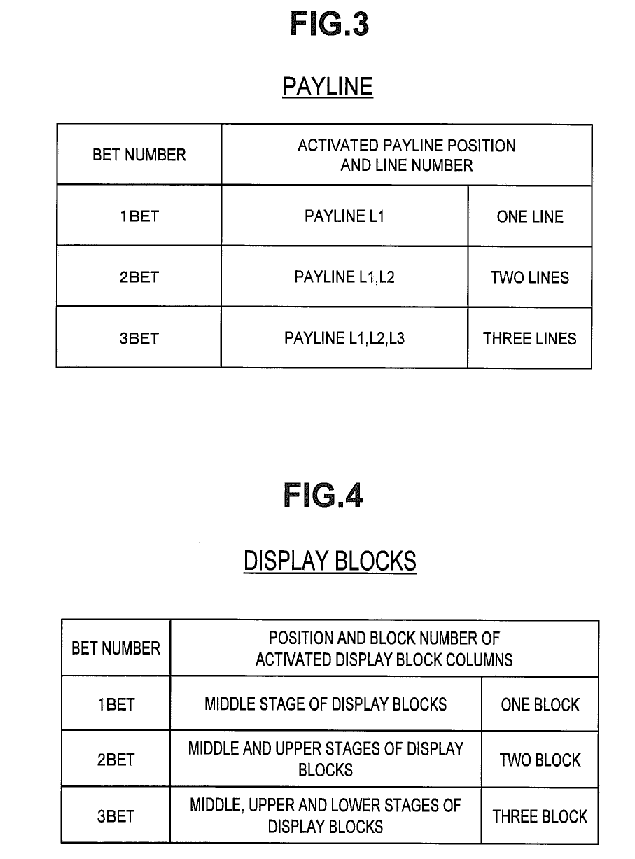

The input devices are BET buttons 26 and 27, and the line number “n” of paylines L is defined to increase with an increased BET number input from the BET button 26 or 27, as shown in FIG. 3. In a case where the BET number is 1BET, a payline L1 is defined, and in a case where it is 2BETS, a payline L2 is defined. In addition, the payline L is activated only when the BET number is input from the BET buttons 26 and 27, and is not activated when no BET number is input from these BET buttons. Therefore, when operation of the BET buttons 26 and 27 is made, games at which “n” activated paylines L were set can be performed. Thus, only a player having made the operation of the BET buttons 26 and 27 has the possibility that a special prize (transition to a future game or payout due to a jackpot) is obtained.

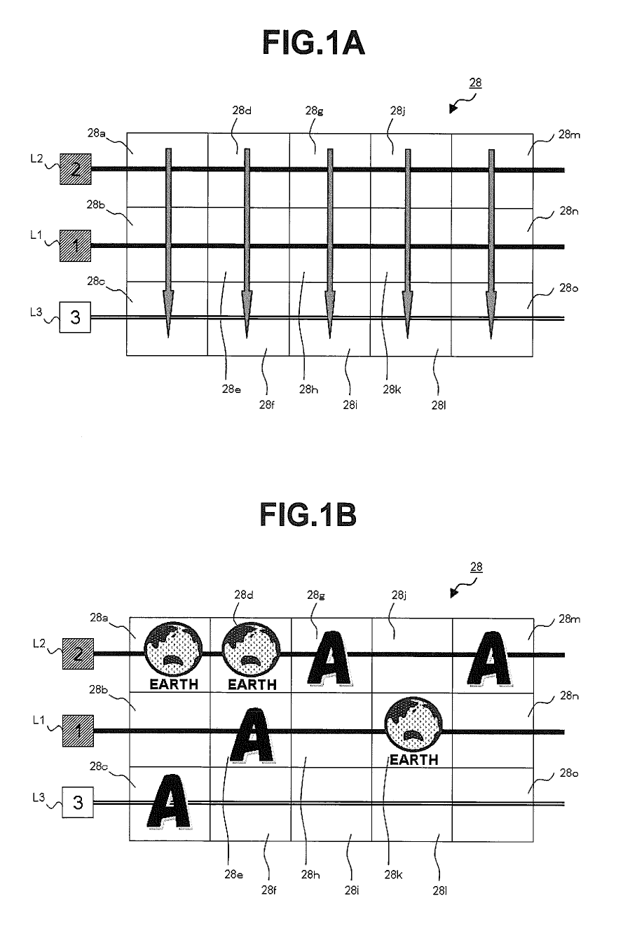

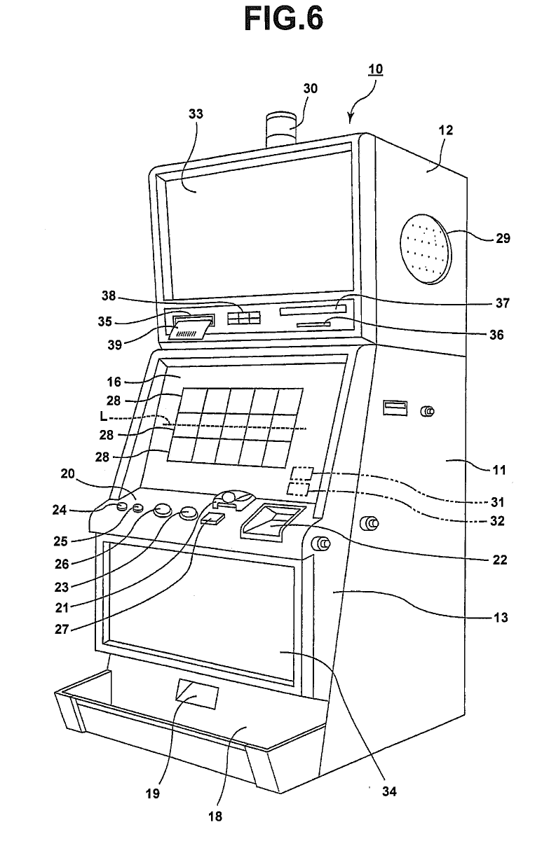

Hereinafter, the slot machine mentioned above will be described in detail. FIG. 1 is a view showing an exemplary display of symbols arranged on a display device. FIG. 3 is a view showing a relationship between BET numbers and paylines. FIG. 5 is a view for explaining a special prize. FIG. 6 is a perspective view showing an appearance of the slot machine.

The slot machine 10, as shown in FIG. 6, is a lower image display panel 16 (display device) made up of a transparent liquid crystal display panel; and BET buttons 26 and 27 for inputting any BET number. In addition, the slot machine 10 has plural types of scatter symbols.

On the lower image display panel 16, as shown in FIG. 1A, 15 display blocks 28 (28a to 28o) are displayed. On this lower image display panel 16, a plurality of paylines L1 to L3 are formed which are displayed at the center of each line and horizontally cross display blocks 28 of 5 columns.

From among the plurality of paylines L1 to L3, as shown in FIG. 3, the positions and line numbers of paylines are determined based upon the BET number input from the BET button 26 or 27. In a case where the input BET number is 1BET, for example, one payline L1 is determined; in a case where it is 2BETS, two paylines L1 and L2 are determined; and in a case where it is 3BETS, three paylines L1, L2, and L3 are determined. Therefore, the payline L is determined to increase with an increased BET number. The determined “n” paylines L (n=1) are activated on the lower image display panel 16.

Scatter symbols are made up of trigger symbols for a special prize, those for a special prize and those for a scatter prize. These symbols are automatically displayed (rearranged) in a scrolling or stopped state by columns in display blocks 28 of the lower image display panel 16. If the trigger symbols for the special prize are displayed in a stopped state by a predetermined number or more on “n” activated paylines L, a special prize (such as a future game) corresponding to the number of displayed symbols is established. In addition, if the trigger symbols for the scatter prize are displayed in a stopped state by a predetermined number or more in any of the display blocks 28, the scatter prize (payout of predetermined number of coins) corresponding to types and number of the display symbols is established. Since, in the following description, all of the symbols are scatter symbols, they are simply referred to as “symbols”.

As described above, in the slot machine 10, as shown in FIG. 5, if a predetermined number of the trigger symbols for the special prize are displayed in a stopped state by a predetermined number on “n” activated paylines, the special prize corresponding to the number of displayed symbols is established apart from coin payout according to the scatter prize. As shown in the figure, in the slot machine 10, in a case where three trigger symbols for the special prize are displayed in a stopped state on “n” activated paylines L, a future game is executed; in a case where four trigger symbols are displayed in a stopped state, the payout of a progressive jackpot is performed; and in a case where five trigger symbols are displayed in a stopped state, both of the future game and the progressive game are executed. That is, in the slot machine 10, the special prize is set to be awarded in accordance with how many trigger symbols for the special prize are rearranged on “n” activated paylines L.

In the slot machine 10, when a game is started by BET number input from the BET button 26 or 27, the BET number input from the BET button 26 or 27 is counted, and then, based upon the counted BET number, “n” paylines L are determined from among the plurality of paylines L1 to L3 (Refer to FIG. 3). Then, the determined “n” paylines are activated in display blocks 28 of the lower image display panel 16. Further, scroll-display of symbols is started by columns of the display blocks 28.

For example, in the slot machine 10, when 2BETS are input from the BET buttons 26 and 27, two paylines L1 and L2 are determined, based upon FIG. 3. In a case where the paylines L1 and L2 are determined, the payline L1 is activated along display blocks 28b, 28e, 28h, and 28n, and the payline L2 are activated along the display blocks 28a, 28d, 28g, 28j, and 28m, as shown in FIG. 1A. In the figure, the downward arrows indicate that plural types of symbols are displayed in a scrolled manner by display block columns.

In the slot machine 10, after the elapse of a predetermined time after scroll-display of symbols has been started, plural types of symbols are displayed (rearranged) in a stopped state in display blocks 28 concurrently when the scroll display is stopped. Then, the number of trigger symbols for the special prize, which were rearranged on “n” activated paylines L, is counted, and the number of plural symbols serving as a trigger for the scatter prize, which were rearranged in display blocks 28, is counted. If three or more trigger symbols for the scatter prize are rearranged in any of the display blocks 28 as the result of counting, the scatter prize is established, and then, coin payout corresponding to the types and number of rearranged symbols and BET number is performed. In addition, if three or more trigger symbols for the special prize are rearranged on one activated payline L, the special prize is established, and then, the special prize (such as a future game) corresponding to the number of rearranged symbols is awarded.

In the slot machine 10, for example, in a state in which two paylines L1 and L2 are activated, in a case where plural types of symbols are displayed in a stopped state in display blocks 28, as shown in FIG. 1B, the number of trigger symbols (for example, “EARTH” symbols) for the special prize, which were displayed in a stopped state on the activated paylines L1 and L2, is counted; and the number of trigger symbols for the scatter prize (for example, “A” symbols), which were displayed in a stopped state in display blocks 28, is counted. As the result of counting, a total of three “EARTH” symbols are displayed in a stopped state on the activated paylines L1 and L2. Thus, the special prize shown in FIG. 5 is established, and a future game is executed. In addition, a total of four “A” symbols are displayed in a stopped state in display blocks 28. Therefore, the scatter prize is established as shown in FIG. 8 described later, and the payout of a predetermined number of coins is not performed.

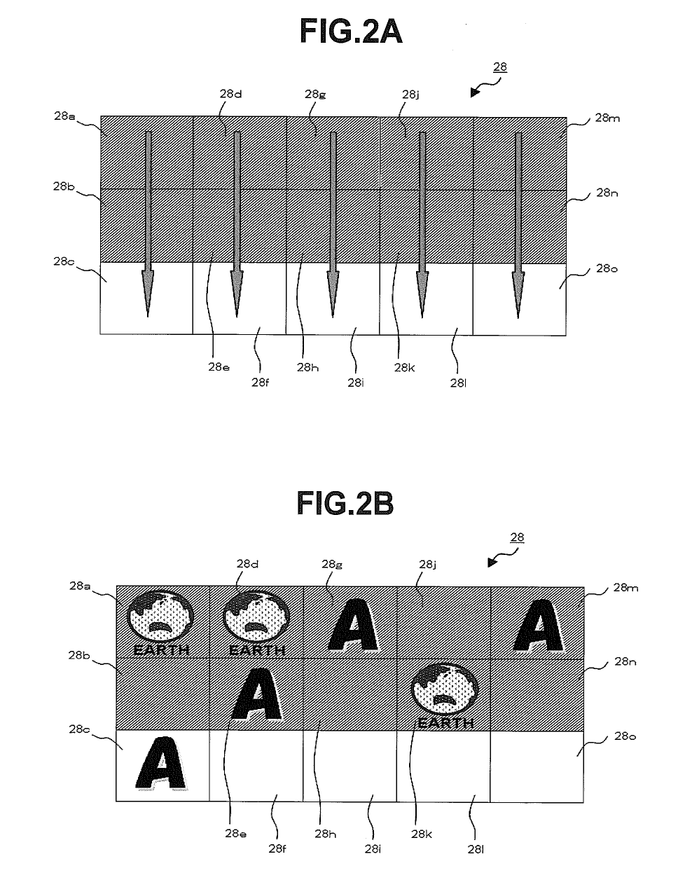

While the above-mentioned example described that the special prize is determined on “n” paylines L (n=1) among the plurality of paylines L1 to L3, the present invention is not limitative thereto. For example, as shown in FIG. 2A, “n” paylines (n=1) are set in an activated display block by columns of a plurality of display blocks 28 (“a” to “o”). With respect to the display blocks 28, for example, as shown in FIG. 4, display block stages by display block columns may be determined depending on the BET number. For example, if the BET number is 2BETS, as shown in FIG. 2A, two display blocks of the middle stage and the upper stage are activated by display block columns. In a case where symbols are thus rearranged, prizes may be determined depending upon how many symbols of the same type have been continuously rearranged in activated display blocks.

While the above-mentioned example described BET buttons for inputting the BET number as an input device according to the present invention, the present invention is not limitative thereto. Any input device may be employed as long as it determines “n” paylines. For example, “n” paylines may be determined by players directly touching a payline or its proximity, on the display device, via a touch screen.

The above-mentioned example described there are two types of prizes, i.e., the special prize and the scatter prize. In addition, it was described that winning determination of the special prize is performed in display blocks 28 on one activated payline, whereas that of the scatter prize is performed in all regions of the display blocks 28. However, the present invention is not limitative thereto, and the winning determination of the scatter prize may be performed in the display blocks 28 on “n” activated paylines as is the case with that of the special prize. In this case, while winning determination of two types of prizes, the special prize and the scatter prize, may be performed on “n” activated paylines, the present invention is not limitative thereto. Winning determination of either of the special prize and the scatter prize may be performed on one activated payline.

The above-mentioned example described that the special prize and the scatter prize are different from each other, and there is no interrelationship therebetween. The present invention is not limitative thereto. For example, in a case where two symbols of the same type are displayed on “n” activated paylines, the magnification may be determined at ×2, and in a case where three symbols of the same type are displayed, the magnification may be determined at ×3. In other words, the magnification may be determined in accordance with the number of symbols of the same type on “n” activated paylines. In addition, prizes may be awarded based upon this magnification and the payout number of coins that serves as a base corresponding to the display number of symbols of the same type, which were displayed in all regions of the display blocks 28. For example, in a case where five symbols of the same type are displayed in all regions of the display blocks 28 (100 coins are paid out), and three symbols of the same type are displayed on “n” activated paylines, the prize may be awarded based upon 100 coins ×3 (symbols).

The above-mentioned example described that the special prize is awarded in a case where three or more trigger symbols for the special prize are displayed on one activated payline, as shown in FIG. 5. However, the present invention is not limitative thereto, and these trigger symbols may not be displayed. In addition, the number of symbols to be rearranged on “n” activated payline can be appropriately varied. Further, contents of the special prize corresponding to the number of symbols on “n” activated paylines can be variously modified.

The above-mentioned example described three paylines L1 to L3 horizontally crossing the display blocks 28 of 5 columns. The present invention is not limitative thereto, and two or less paylines, or alternatively, four or more paylines may be activated. In addition, the number of paylines may be irregularly varied without being fixed. Further, oblique paylines or crossing paylines, for example, may be activated instead of the straight paylines.

The above-mentioned example described that a similar special prize is awarded even in a case where any of the plurality of paylines L1 to L3 has been determined. However, the present invention is not limitative thereto, and the special prize may be provided which corresponds to the positions of the activated paylines, which were determined, and the number of symbols.

The above-mentioned example described that determination and setting of the activated payline are performed while they are triggered by BET number input from the BET button. However, the present invention is not limitative thereto, and, even in a case where BET number is not input from the BET button, the determination and setting of the activated payline may be performed. In addition, while it was described above that the determination and setting of the payline are performed prior to starting scroll-display of symbols the present invention is not limitative thereto. For example, the above determination and setting may be performed after the scroll-display of symbols has been stopped.

While the above-mentioned example described a case of displaying a total of 15 symbols made up of 5 columns and 3 rows, a display mode of symbols in the present invention is not limitative to 5 columns and 3 rows. This display mode is applicable to various combinations such as a combination of symbols made up of 3 columns and 3 rows. In addition, while the above-mentioned example described a case in which symbols are displayed in a scrolled manner by display blocks, these symbols may be individually displayed in a scrolled manner.

While the above-mentioned example described that symbols are displayed in a scrolled manner using a liquid crystal display device or the like, the present invention is not limitative thereto. In a case where mechanical reels are employed, the symbols may be graphically displayed on the surface of the mechanical reels.

Next, a construction of the slot machine will be described with referring to FIG. 6. While the slot machine in the present embodiment is a video-type slot machine, the present invention is also applicable to a mechanical reel type slot machine. In addition, while the slot machine 10 is of standalone type, which is not connected to a network, the present invention is also applicable to a slot machine connected to a network.

In the slot machine 10, coins, bills or electronic valid information equivalent thereto are employed as gaming media. In the present invention, however, the gaming media are not limitative thereto in particular, and can include medals, tokens, electric money, and tickets, for example. The above tickets are not limitative thereto in particular, and can include bar code-attached tickets or the like, as described later, for example.

The slot machine 10 is provided with: a cabinet 11; a top box 12 installed at the upper side of the cabinet 11; and a main door 13 provided at the front face of the cabinet 11.

In front of the main door 13, a lower image display panel 16 is provided as a display device. The lower image display panel 16 is provided with a transparent liquid crystal display panel, and 15 display blocks 28 (28a to 28o) of 5 columns and 3 rows are displayed. One symbol is displayed in each of the display blocks 28. The lower image display panel 16 is equivalent to the display device according to the present invention.

In addition, a credit amount display portion 31 and a payout number display portion 32 are set on the lower image display panel 16. At the credit amount display portion 31, the number of credited coins is displayed by way of image. At the payout display portion 32, the number of coins paid out in a case where symbols of the same type are displayed in a stopped state by a predetermined number or more in the display blocks 28, is displayed by way of image.

Further, on the front face of the lower image display panel 16, a touch panel 69 is provided, although not shown, so that a player can enter various instructions by operating the touch panel 69.

Provided downwardly of the lower image display panel 16 are: a control panel 20 made of a plurality of buttons 23 to 27 for a player to input instructions associated with the progress of a game; a coin insertion slot for accepting coins in the cabinet 11; and a bill validator 22.

On the control panel 20, a SPIN button 23, a CHANGE button 24, a CASHOUT button 25, a 1-BET button 26, and a MAX-BET button 27 are provided. The SPIN button 23 is intended to enter an instruction for starting scroll-display of symbols. The CHANGE button 24 is employed when a player requests the attendant in game facility to change money. The CASHOUT button 25 is intended to enter an instruction for paying out credited coins to a coin tray 18.

The 1-BET button 26 is intended to enter an instruction for betting one coin on a game from among the credited coins. The MAX-BET button 27 is intended to enter an instruction for betting the maximum number of coins (50 coins in the present embodiment) that can be betted in one game. The 1-BET button 26 and the MAX-BET button 27 are equivalent to an input device according to the present invention.

The insertion of gaming media denotes that gaming media are betted on games. For example, in a case where the coins inserted into the coin insertion slot 21 are directly betted on games, coin insertion into the coin insertion slot 21 is equivalent to insertion of gaming media. More specifically, if coins are inserted into the coin insertion slot 21, they are temporarily credited. When the 1-BET button 26 and the MAX-BET button 27 are operated, the credited coins are betted on games. In this case, the fact that the credited coins are betted on games is equivalent to insertion of gaming media.

The bill validator 22 validates whether or not bills are valid and accepts valid bills in the cabinet 11. The bill validator 22 may be constructed so that bar code-attached tickets 39 described later are readable thereby. Provided on the lower front face of the main door 13, i.e., downwardly of the control panel 20 is a belly glass 34 on which a character or the like of the slot machine 10 were expressed.

An upper image display panel 33 is provided on the front face of the top box 12. The upper image display panel 33 is provided with a liquid crystal display panel, and displays images representative of an introduction to the contents of a game or explanation of game rules. In addition, the lower image display panel 33 displays effect images when a future game or a progressive jackpot is established as a special prize.

In addition, a speaker 29 is provided at the top box 12. At the lower side of the upper image display panel 33, a ticket printer 35, a card reader 36, a data display 37, and a keypad 38 are provided. The ticket printer 35 prints, on tickets, bar codes having coded therein a variety of data including credit number, date and time, and identification number of slot machine 10. The printed tickets are output as bar code-attached tickets 39. A player causes another slot machine to read the bar code-attached tickets 39, allowing the slot machine to perform games, or alternatively, allowing the exchange of bar code-attached tickets 39 with bills or the like at a predetermined site of a game facility (for example, at the casher in a casino).

The card reader 36 is intended to read and write data from/into a smart card. The smart card is a player-owned card, and stores data for recognizing the player and data concerning the log of games that were performed by the player. The smart card may store data equivalent to coins, bills, or credits. In addition, a magnetic stripe card may be employed in place of the smart card. A data display 37 is made up of a fluorescent display or the like, and displays the data read by the card reader 36 and the data input by the player via the keypad 38, for example. The keypad 38 is intended to input the instructions and data concerning the issuance of tickets or the like.

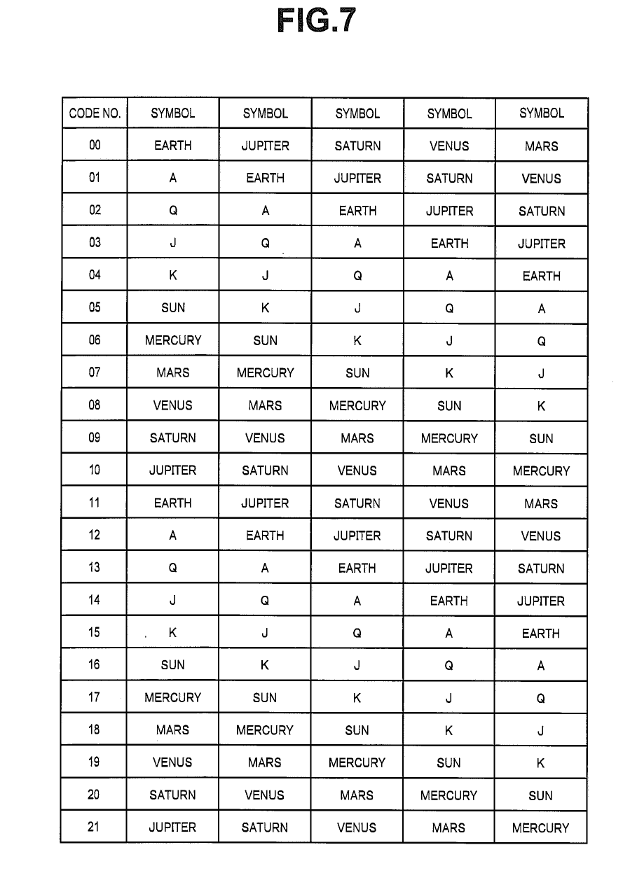

FIG. 7 is a view illustrating symbols and code numbers displayed by display block columns. As shown in FIG. 7, in display blocks 28, the columns of a total of 22 symbols made up of code numbers 00 to 21 are displayed in a scrolled manner. The column of symbols is constituted while symbols “EARTH”, “JUPITER”, “SATURN”, “SUN”, “VENUS”, “MARS”, “MERCURY”, “K”, “J”, “Q”, and “A” are combined with each other. These symbols are all scatter symbols.

FIG. 8 is a view for explaining a scatter prize. The symbols “JUPITER”, “SATURN”, “SUN”, “VENUS”, “MARS”, “MERCURY”, “K”, “J”, “Q”, and “A” are trigger symbols for the scatter prize. Among these symbols, in a case where three or more symbols of the same type are displayed (rearranged) in any of the display blocks 28 of the lower image display panel 16, a predetermined number of coins are paid out as the scatter prize corresponding to the types and number of symbols and BET number. The payout of coins is performed based upon FIG. 5. For example, as shown in FIG. 5, if three “JUPITER” symbols are displayed in a stopped state in any of the display blocks 28, 70 coins are paid out; if four “JUPITER” symbols are displayed in a stopped state, 140 coins are paid out; and if five “JUPITER” symbols are displayed in a stopped state, 280 coins are paid out (these coin payout numbers are calculated for one coin entry).

“EARTH” is a trigger symbol for the special prize. In a case where the three or more “EARTH” symbols are displayed in a stopped state on “n” activated paylines L, the special prize is established. Then, the special prize corresponding to the number of symbols is awarded, based upon FIG. 5.

The special prize shown in FIG. 5 will be described. In a case where the three “EARTH” symbols are displayed in a stopped state on “n” activated paylines L, a future game trigger is established. In this future game, a free game is executed by a predetermined number of times that was determined based upon the random number value obtained by executing a random number generation program included in the symbol determination programs. The above-mentioned free game is a game which the player can perform without betting coins.

In a case where the four “EARTH” symbols are displayed in a stopped state on “n” activated paylines L, a progressive jackpot trigger is established. If this progressive jackpot is established, a large amount of coins are paid out, based upon the progressive value obtained by accumulatively adding the BET number from the BET button pressed in each game.

In a case where five “EARTH” symbols are successively displayed in a stopped state on “n” paylines L, a trigger of both of the future game and the progressive jackpot is established. Three symbols of the same type are equivalent to a first number of the present invention, four symbols thereof are equivalent to a second number of the present invention, and five symbols thereof are equivalent to a third number of the present invention. In addition, the future game is equivalent to a first prize of the present invention, and the progressive jackpot is equivalent to a second prize of the present invention.

Hereinafter, a game outline will be described. When a game is started by BET number input from the 1-BET button 26 or the MAX-BET button 27, “n” paylines L (n=1) are determined from among a plurality of paylines L1 to L3. Then, the determined “n” paylines L are activated in display blocks 28 of the lower image display panel 16. Then, plural types of symbols are displayed in a downwardly scrolled manner by columns in the display blocks 28. Then, after the elapse of a predetermined time after scroll-display has been started, plural types of symbols are displayed (rearranged) in a stopped state in display blocks 28 concurrently when the scroll-display is stopped. After that, the number of “EARTH” symbols serving as a trigger for the special prize, which were rearranged on the “n” activated paylines L, is counted, and the number of trigger symbols for the scatter prize, which were rearranged in display blocks 28, is counted. As the result of counting, if three or more symbols of the same type serving as a trigger for the scatter prize are rearranged in any of display blocks 28, the scatter prize of FIG. 5 is established. After that, coins are paid out corresponding to the types and number of rearranged symbols and BET number. In addition, if three or more “EARTH” symbols serving as a trigger for the special prize are rearranged on “n” activated paylines L, the special prize of FIG. 5 is established. Then, the special prize (such as a future game) corresponding to the number of rearranged “EARTH” symbols is awarded.

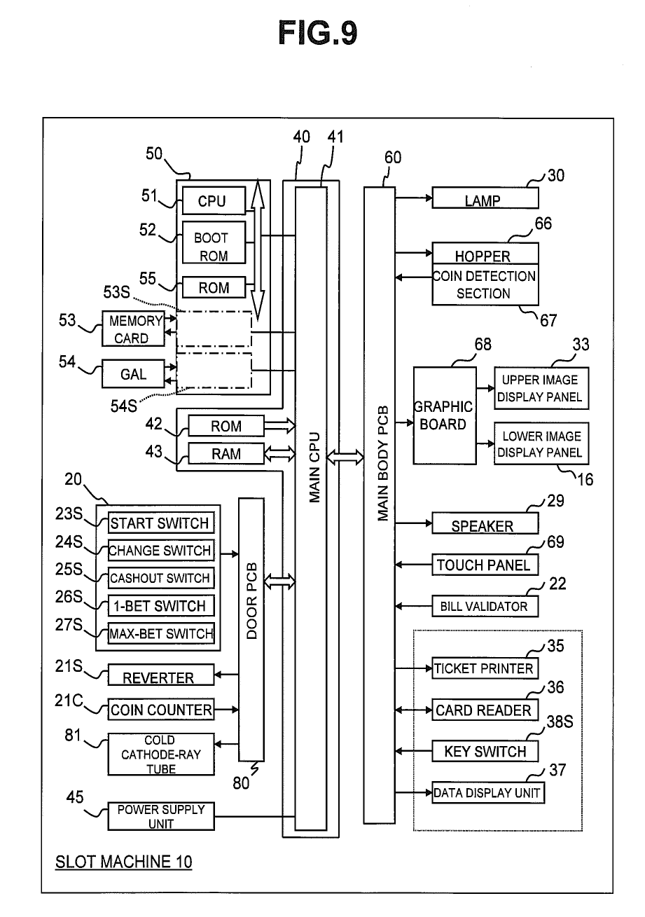

FIG. 9 is a block diagram depicting an internal construction of a slot machine. A gaming board is provided with: a CPU (Central Processing Unit) 51, a ROM 55, and a boot ROM 52, which were interconnected via an internal bus; a card clot 53S compatible with a memory card 53; and an IC socket 54S compatible with a GAL (Generic Array Logic) 54.

The memory card 53 is made up of non-volatile memories such as CompactFlash (registered trademark), and stores game programs. The game programs contain a symbol determination program. The symbol determination program is intended for determining symbols (code Nos. corresponding to the symbols) which are displayed in a stopped state along the payline L.

The card slot 53S is constituted such that the memory card 53 can be inserted into or drawn out from, and is connected to a motherboard 40 through an IDE bus. Therefore, the types or contents of games played in the slot machine 10 can be changed by removing the memory card 53 from the card slot 53S, writing different game programs into the memory card 53, and then, inserting the memory card 53 into the card slot 53S. The game programs include those related to the progress of a game. The game programs further include: image data and sound data output at the time of the play of a game.

The CPU 51, the ROM 55, and the boot ROM 52 interconnected via the internal bus are connected to the motherboard 40 via a PCI bus. The PCI bus not only performs signal transmission between the motherboard 40 and the gaming board 50, but also supplies power from the motherboard 40 to the gaming board 50.

The motherboard 40 is constructed with a commercially available general-purpose motherboard (a printed circuit board on which the essential parts of a personal computer are mounted). This motherboard includes: a main CPU 41; a ROM (Read Only Memory) 42; a RAM (Random Access Memory) 43; and a communication interface (not shown). The motherboard 40 functions as the controller of the present invention.

The ROM 42 is made up of a memory device such as a flash memory, and stores a program such as a BIOS (Basic Input/Output System) executed by the main CPU 41 and permanent data. When the main CPU 41 executes the BIOS, initialization processing is performed for predetermined peripheral devices, and capture processing of the game program stored on the memory card 53 is also started via the gaming board 50. In the present invention, the contents of the ROM 42 may be rewritable or not.

The RAM43 stores data and programs employed when the main CPU41 is activated. In addition, the RAM43 can store game programs. Further, the RAM43 stores data such as BET number input from the BET button; the number of symbols arranged on “n” activated paylines or the number of symbols arranged in each of the display blocks 28; credit amount; and coin entry number or payout number in one game.

Both a body PCB (Printed Circuit Board) 60 and a door PCB80, which will be described later, are connected to the motherboard 40 by the USB. A power supply unit 45 is also connected to the motherboard 40.

Equipment and devices, which generate input signals to be input to the main CPU 41, and equipment and devices, operations of which are controlled by a control signal output from the main CPU 41, are connected to the body PCB 60 and the door PCB80. The main CPU 41 executes the game programs stored in RAM43, based upon an input signal that was input to the main CPU 41, thereby performing predetermined computational processing. Then, this CPU stores results thereof into RAM43; and transmits control signals to equipment and devices as control processing relative to the equipment and devices.

A lamp 30, a hopper 66, a coin detecting section 67, a graphic board 68, a speaker 29, a touch panel 69, a bill validator 22, a ticket printer 35, a card reader 36, a key switch 38S and a data display 37, are connected to the body PCB 60. The lamp 30 is lit up in a predetermined pattern, based upon a control signal output from the main CPU 41.

The hopper 66 is installed in the cabinet 11. This hopper pays out a predetermined number of coins from a coin payout exit 19 to a coin tray 18, based upon a control signal output from the main CPU 41. A coin detecting section 67 is installed inside the coin payout exit 19. This detecting section outputs an input signal to the main CPU 41 at the time of detecting that a predetermined number of coins have been paid out from the coin payout exit 19.

The graphic board 68 performs control, based upon a control signal output from the main CPU 41. This graphic board displays images on the upper image display panel 33 and the lower image display panel 16 that serves as an output device. The background colors determined through selection of random numbers are displayed, and also, symbols are displayed in a scrolling or stopped state, in the respective display blocks 28 on the lower image display panel 16. The number-of-credits display section 31 on the lower image display panel 16 displays the number of credits stored in the RAM43. Further, the number-of-payouts display section 32 on the lower image display panel 16 displays the number of coins to be paid out. The graphic board 68 is equipped with: a VDP (Video Display Processor), which generates image data based upon a control signal output from the main CPU 41; and a video RAM, which temporarily stores image data generated by the VDP or the like. The image data used in generating image data by the VDP is read from the memory card 53. The read image data is contained in the game programs stored in the RAM43.

The bill validator 22 not only discriminates a valid bill from an invalid bill, but also accepts the valid bill into the cabinet 11. At the time of accepting a valid bill, the bill validator 22 outputs an input signal to the main CPU41 based upon a face amount of the bill. The main CPU41 stores the number of credits corresponding to the amount of the bill transmitted with the input signal.

The ticket printer 35, based upon a control signal output from the main CPU41, prints on a ticket a bar code obtained by encoding data such as the number of credits, date and time, and the identification number of the slot machine 10 stored in the RAM43. The printed bar-code ticket is output as the bar code-attached ticket 39. The card reader 36 transmits, to the main CPU41, the data read from the smart card, and writes the read data onto the smart card, based upon a control signal from the main CPU41. The key switch 38S is provided on the key pad 38, and outputs a predetermined input signal to the main CPU41 when a player operates the key pad 38. The data display 37 displays, based upon a control signal output from the main CPU 41, the data read by the card reader 36 and the data input by a player through the key pad 38.

The control panel 20, a reverter 21S, a coin counter 21C, and a cold cathode-ray tube 81 are connected to the door PCB80. The control panel 20 is provided with: a SPIN switch 23S corresponding to the SPIN button 23; a CHANGE switch 24S corresponding to the CHANGE button 24; a CASHOUT switch 25S corresponding to the CASHOUT button 25; a 1-BET switch 26S corresponding to the 1-BET button 26; and a MAX-BET switch 27S corresponding to the MAX-BET button 27. When a player operates the buttons 23 to 27, the switches 23S to 27S corresponding thereto output input-signals to the main CPU41, respectively.

The coin counter 21C is installed inside the coin receiving slot 21. This coin counter discriminates whether a coin inserted by a player into the coin receiving slot 21 is valid or invalid. Those other than the valid coins are discharged from the coin payout exit 19. The coin counter 21C also outputs an input signal to the main CPU41 if an invalid coin is detected.

The reverter 21S operates based upon a control signal output from the main CPU41 and distributes valid coins recognized by the coin counter 21C into a cash box (not shown) or the hopper 66, which is disposed in the slot machine 10. In other words, when the hopper 66 is filled with coins, valid coins are distributed into the cash box. On the other hand, when the hopper 66 is not filled with coins, valid coins are distributed into the hopper 66. The cold cathode-ray tube 81 works as a backlight installed on the back face side of each of the lower image display panel 16 and the upper image display panel 33. This backlight is lit up based upon a control signal output from the main CPU41.

Next, the processing performed in the slot machine 10 will be described with referring to the drawings. The main CPU41 conducts a game by reading and executing the game programs stored in the RAM43.

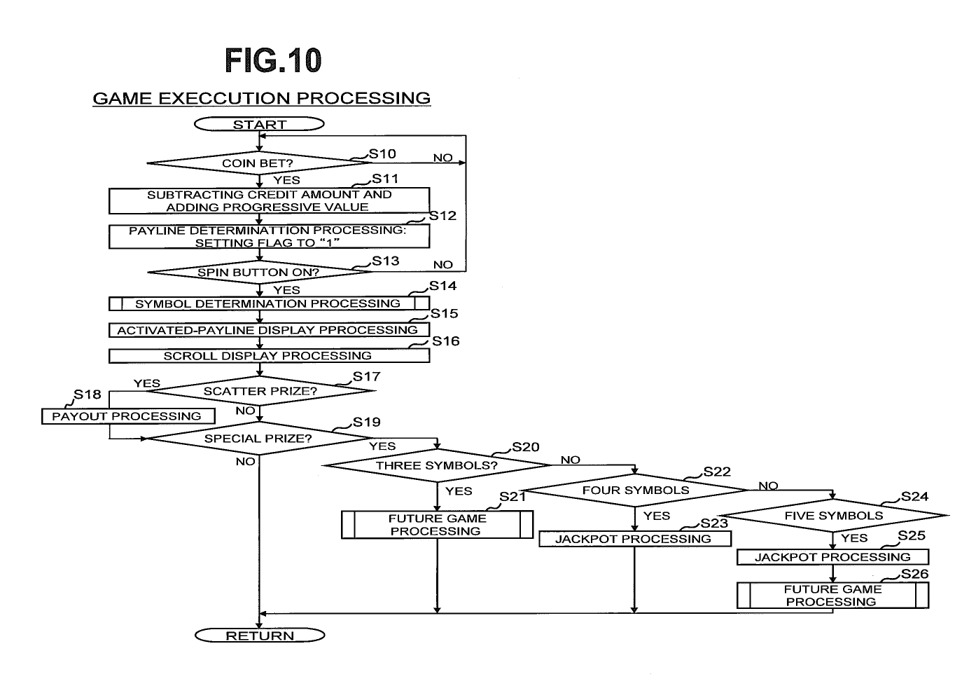

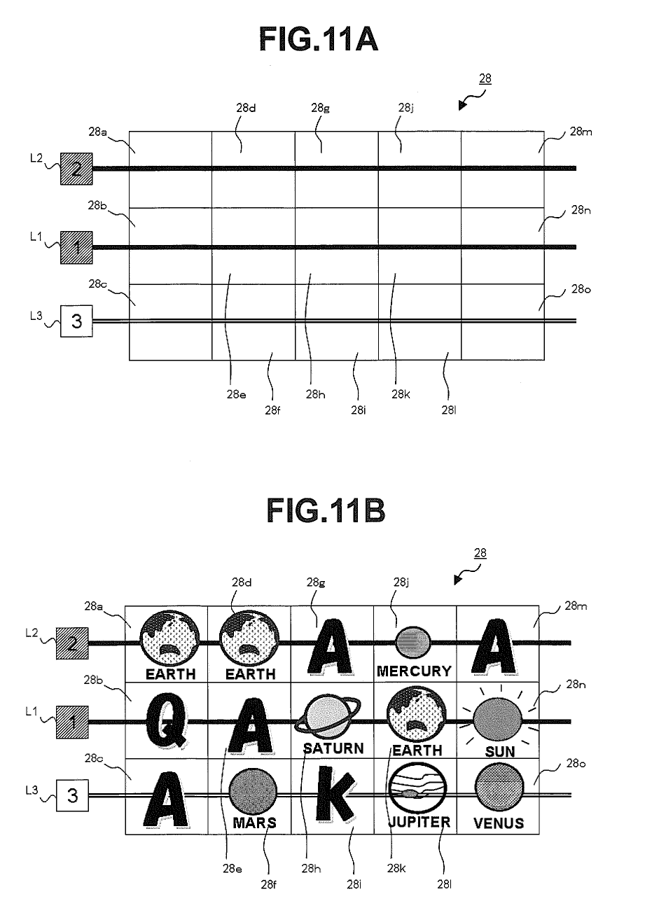

First, game execution processing will be described. FIG. 10 is a flowchart showing a subroutine of the game execution processing. FIGS. 11A and 11B are views each showing an exemplary display of symbols arranged on the display device, wherein FIG. 11A shows a state in which a plurality of paylines are activated on the display device, and FIG. 11B shows a state in which a plurality of symbols are rearranged on the display device.

As shown in FIG. 10, at step S10, the main CPU41 judges whether or not coins have been betted. In this processing operation, the main CPU judges whether or not the input signal output from the 1-BET switch 27S has been received when the 1-BET button 26 has been operated; or alternatively, whether or not the input signal outputted from the MAX-BET switch 27S has been received when the MAX-BET button has been operated. In a case where the main CPU41 judges that no coin has been betted (S10: NO), the routine reverts to step S10, and in a case where the CPU judges that coins have been betted (S10: YES), the routine proceeds to step S11. The BET number input from the BET button 26 or 27 is stored in the RAM43 after it is counted. In the present embodiment, the BET number is counted as 1BET.

Next, in a case where it is judged that coins have been betted at step S10, the main CPU performs processing of subtracting the credit amount stored in the RAM43 in accordance with the number of betted coins at step S11. In addition, the main CPU41 performs processing of adding, in an accumulative manner, to the progressive value of the progressive jackpot that is a special prize in response to the number of coins betted by the BET buttons 26 and 27. Therefore, the progressive values of the progressive jack pot are added in an accumulative manner, based upon the BET number, as described previously, so that the payout value of a coin with high payment is set.

Next, in a case where coins have been betted at step S10, the main CPU41 performs payline determination processing at step S12. Specifically, the main CPU41 sets a payline determination flag to “1”, based upon input signals from the BET buttons 26 and 27. In addition, the main CPU41 determines the position of the payline L employed in games, depending upon the BET number input from the BET button 26 or 27. With respect to the position of this payline L, as shown in FIG. 3, in a case where the BET number is 1BET, it is determined to be the payline L1; in a case where it is 2BETS, it is determined to be the paylines L1 and L2; and in a case where it is 3BETS, it is determined to be the paylines L1, L2, and L3. Therefore, the position and line number of paylines L are determined depending upon the BET number to increase with an increased BET number. Since, in the present embodiment, the BET number is 2BETS, the two activated paylines L1 and L2 are determined.

Next, at step S13, the main CPU41 judges whether or not the SPIN button 23 has been set to ON. Specifically, the main CPU41 judges whether or not the input signal outputted from the SPIN switch 23S has been received when the SPIN button 23 has been depressed. In a case where the main CPU41 judges that the SPIN button 23 has not been turned ON (S13: NO), the routine reverts to step S10, and in a case where the CPU judges that the SPIN button 23 has been set to ON, the routine proceeds to step S13. In a case where it is judged that the SPIN button 23 has not been set to ON (for example, in a case where an instruction has been input to terminate a game without turning ON the SPIN button 23), the main CPU41 cancels acceptance of a credit amount subtraction result of step S11.

Next, at step S14, the main CPU41 performs symbol determination processing. Specifically, the main CPU41 judges that the SPIN button 23 has been set to ON at step S13, it determines code No. at the time of stoppage of symbol scrolling by executing the symbol determination programs stored in the RAM43. This processing operation will be described later in detail with referring to FIG. 9. The present embodiment describes a case of determining one or plural prizes from among plural types of prizes by determining symbols displayed in a stopped state. However, the present invention is not limitative thereto, and, for example, is applicable to a case in which one or a plurality of prizes selected from among the plural types of prizes are determined, and then, the combinations of symbols displayed in a stopped state are determined based upon the above-mentioned prizes.

Next, at step S15, the main CPU41 performs processing of displaying activated paylines. Specifically, the main CPU41 displays (sets) two paylines L1 and L2, which were determined at step S12, in display blocks 28 in a state in which the payline is visually recognizable to players. FIG. 11A shows a state in which the payline L1 is activated along display blocks 28b, 28e, 28h, 28k, and 28n arranged on one straight line, and the payline L2 is activated in display blocks 28a, 28d, 28g, 28j, and 28m.

Next, at step S16, the main CPU41 performs scroll-display processing. Specifically, the main CPU41 starts scroll-display of plural types of symbols, and then, performs display control so that the symbols determined at step S14 are displayed in a stopped state in display blocks 28, concurrently when the scroll-display is stopped after the elapse of a predetermined time.

Next, at step S17, the main CPU41 judges whether or not a scatter prize is established. Specifically, the main CPU41 judges whether or not three or more symbols for the scatter prize are displayed in a stopped state in any of display blocks 28, and the scatter prize is established at step S16. More specifically, this CPU judges, based upon FIG. 8, whether or not three or more symbols of the same type are displayed in a stopped state from among “JUPITER”, “SATURN”, “SUN”, “VENUS”, “MARS”, “MERCURY”, “K”, “J”, “Q”, and “A”. In a case where the main CPU41 judges that the scatter prize is established, based upon FIG. 8 (S17: YES), the routine proceeds to step S18 at which coin payout processing is performed. In a case where this CPU judges that the scatter prize is not established (S17: NO), the routine proceeds to step S19 without performing coin payout.

Next, at step S18, the main CPU41 executes payout processing. Specifically, in a case where the main CPU41 judges that three or more trigger symbols for the scatter prize, of the same type, have been displayed in a stopped state at step S17, this CPU executes payout of a predetermined number of coins, which corresponds to the types and number of symbols displayed in a stopped state and the BET number, based upon FIG. 8. In FIG. 11B, four “A” symbols are rearranged in display blocks 28c, 28e, 28g, and 28m from among the display blocks 28. Therefore, six coins are paid out as the scatter prize, based upon FIG. 8 (for one coin entry).

Next, at step S19, the main CPU41 judges whether or not the special prize is established. The processing at step S19 is performed in a case where it is judged that the scatter prize is not established at step S17 or in a case where coin payout processing due to the establishment of the scatter prize has completed. The main CPU41 judges whether or not the three or more “EARTH” symbols serving as a trigger for the special prize have been displayed in a stopped state, based upon FIG. 5, on the paylines L1 and L2 that were activated at step S15. Then, in a case where the main CPU41 judges that the special prize is established (S19: YES), the routine proceeds to step S20, step S22, and then, to step S24, and in a case where this CPU judges that the special prize is not established (S19: NO), this subroutine is terminated. The counting of the number of symbols of the same type in the present embodiment denotes that it is judged, by symbol columns (columns of display block 28), whether or not the “EARTH” symbols corresponding to code Nos. “00”, “01”, “02”, “03”, and “04” in symbol columns determined in the symbol determination processing of step S14 are displayed in a stopped state on the activated paylines.

In a case that the main CPU41 judges that the scatter prize is not established at step S17 (S17: NO) and in a case where this CPU judges that the special prize is not established at step S19 (S19: NO), it is determined to be “losing”, that does not come under any of the prizes shown in FIGS. 2 and 5. The above-mentioned “losing” denotes a case in which no coin payout is performed.

Next, a case in which the routine proceeds to step S20, step S22, and then, to step S24, will be described. First, at step S20, in a case where the main CPU41 judges that the special prize is established at step S19, this CPU judges whether or not three “EARTH” symbols serving as the trigger for the special prize have been successively displayed in a stopped state on the activated paylines L1 and L2. Then, in a case where the main CPU41 judges that three “EARTH” symbols are successively displayed in a stopped state on the activated paylines L1 and L2 (S20: YES), the routine proceeds to step S21 at which future game processing is executed. Alternatively, in a case where it is judged that three “EARTH” symbols are not displayed in a stopped state (S20: NO), the routine proceeds to step S22.

Next, at step S21, the main CPU41 executes future game processing as a special prize. Specifically, when the main CPU41 judges that three “EARTH” symbols are successively displayed in a stopped state on the activated paylines L1 and L2, the special prize of FIG. 5 is established, and then, the future game corresponding to the three symbols is executed.

In FIG. 11B, the “EARTH” symbols are displayed in a stopped state in the display block 28k of the activated payline L1 and in display blocks 28a and 28d of the activated payline L2. Therefore, a total of three “EARTH” symbols are rearranged on the two activated paylines L1 and L2, and thus, the special prize of FIG. 5 is established, and a future game according to the number of symbols is executed as the special prize.

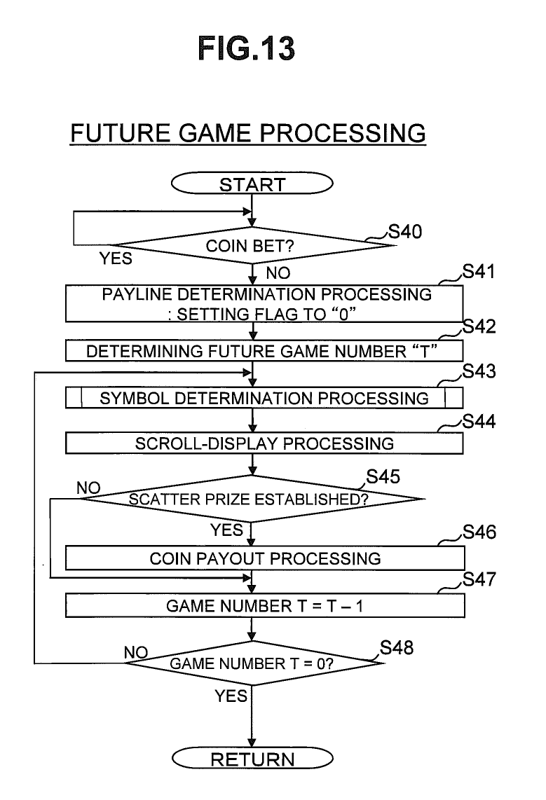

At the step S21, the main CPU41 reads, from the RAM43, a program for performing a future game at the time of executing future game processing. Then, at the time of starting the future game, the main CPU41 executes the random number generation program included in the symbol determination programs to select a random number value. After that, this CPU executes a free game by a predetermined number of times, based upon the selected random number value. After the future game processing has been executed, the main CPU41 executes coin payout, based upon the payout number of coins acquired in the future game processing, and then, terminates this subroutine. The future game processing will be described later in detail with referring to FIG. 13.

Next, at step S22, the main CPU41 judges whether or not four “EARTH” symbols are displayed in a stopped state on two activated paylines L1 and L2, in a case where the CPU judges that three “EARTH” symbols are not displayed in a stopped state at the step S20 mentioned previously (S20: NO). After that, in a case where the main CPU41 judges that four “EARTH” symbols are displayed in a stopped state on the activated paylines L1 and L2 (S22: YES), the routine proceeds to step S23 at which jackpot processing is executed. In a case where the CPU judges that four “EARTH” symbols are successively displayed in a stopped state on the activated paylines L1 and L2 (S22: NO), the routine proceeds to step S24.

Next, at step S23, the main CPU41 executes jackpot processing as a special prize. Specifically, when the main CPU41 judges that four “EARTH” symbols are displayed in a stopped state on the activated payline at step S22, the special prize of FIG. 2 is established, and then, jackpot processing is executed as a special prize corresponding to the four “EARTH” symbols. In the jackpot processing, a large amount of coins is paid out as a prize of a progressive jackpot, based upon the progressive value added in an accumulative manner corresponding to the BET number at step S11. Then, the main CPU41 terminates this subroutine after the predetermined number of coins has been paid out.

Next, at step S24, the main CPU41 judges whether or not five “EARTH” symbols are successively displayed in a stopped state on one activated payline L1 in a case where the CPU judges that four “EARTH” symbols are not displayed in a stopped state on the activated two paylines L1 and L2 (S22: NO). Then, in a case where the main CPU41 judges that five “EARTH” symbols are displayed in a stopped state on the activated payline L1 (S24: YES), the routine proceeds to step S25 and then, to step S26.

Next, at the steps S25 and S26, the main CPU41 executes both of future game processing and jackpot processing as a special prize. Specifically, when the CPU41 judges that five “EARTH” symbols are displayed in a stopped state on the activated payline L1, the special prize of FIG. 5 is established, and then, future game processing and jackpot processing are executed as a special prize corresponding to the five symbols. A description of processing operations at the steps S25 and S26 is omitted hereinafter, since it is substantially identical to that at the steps S21 and S23. After the future game has been terminated at step S26, the main CPU41 pays out a predetermined number of coins acquired in future game processing and jackpot processing, and then, terminates this subroutine.

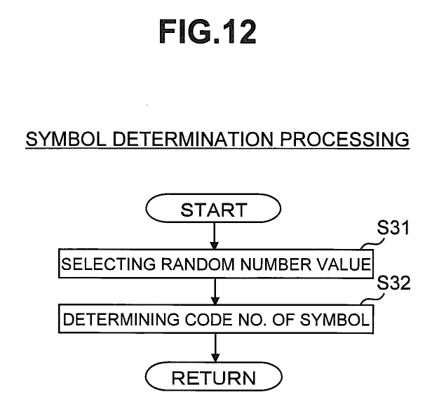

Next, symbol determination processing will be described. FIG. 12 is a flowchart showing a subroutine of symbol determination processing executed at step S14 shown in FIG. 10. This processing is performed by executing the symbol determination program stored in the RAM43.

First, at step S31, the main CPU41 executes processing of selecting a random number value. Specifically, the main CPU41 executes the random number generation program included in the symbol determination program, thereby selecting five random number values corresponding to each of the symbol columns (5 columns) from among the numeric values ranging from 0 to 255. The present embodiment describes a case in which random numbers are generated on a program (a case in which so-called software random numbers are employed). In the present invention, however, a random number generator is provided whereby random numbers may be extracted from the random number generator (so-called hardware random numbers may be employed).

Next, at step S32, code Nos. of symbol columns (refer to FIG. 7) are determined, based upon the five random number values selected at step S31. Code Nos. of the symbol columns correspond to those of symbols displayed in a stopped state on the payline. The main CPU determines prizes by determining code Nos. of symbol columns. As shown in FIG. 4, for example, in a case where code Nos. of symbols have been determined to be “00”, “01”, “02”, “03”, and “04”, the prize is determined to be “EARTH”.

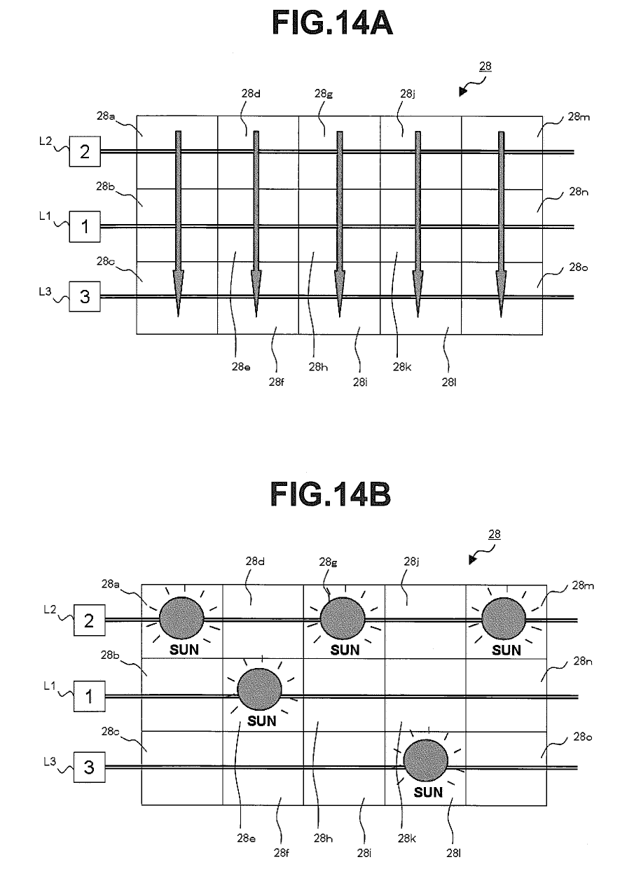

Next, future game processing will be described. FIG. 13 is a flowchart showing a subroutine of the future game processing executed at steps S21 and S26 shown in FIG. 10. FIGS. 14A and 14B are views each showing an exemplary display of symbols arranged on the display device, wherein FIG. 14A is a view showing a state in which scroll-display of symbols has been started, and FIG. 14B is a view showing that a plurality of symbols are rearranged on the display device. In the future game, only the scatter prize is set as a prize of determining coin payout number of coins in accordance with the types and number of symbols displayed in all regions of display blocks 28 without considering an activated payline, and the special prize is not set.

First, at step S40, the main CPU41 judges whether or not coins have been betted from the BET buttons 26 and 27. The main CPU41 repeats the processing at the step in a case where coins have been betted (S40: YES) in a case where it is determined that coins have been betted, and proceeds to step S41 in a case where it is determined that no coins have been betted (S40: NO). In the future game processing, a free game is performed by the BET buttons 26 and 27 without inputting any BET number.

Next, at step S41, the main CPU41 performs payline determination processing. Hereinafter, the main CPU41 sets a payline determination flag to “0”. In this manner, the processing of determining a payline, as shown at step S12 of FIG. 7, is not performed. Concurrently, the setting of an activated payline, as shown at step S15 of FIG. 7, is not provided. That is, in the future game, gaming is performed in a state in which none of the activated paylines exists.

Next, at step S42, the main CPU41 selects future game (free game) number T executed in the future game. Specifically, the main CPU41 determines game number T from among any of 10 to 25 games, based upon the random number values obtained by executing the random number generation programs stored in the RAM43. The main CPU41 stores, as data in the RAM43, the game number T executed in the thus determined future game.

Next, at steps S43 and S44, the main CPU41 performs symbol determination processing and scroll-display processing. A description of processing operations at the steps S43 and S44 is omitted hereinafter, since it is substantially identical to that at steps S14 and S16 shown in FIG. 10. As shown in FIG. 14A, in the future game, the scroll-display of symbols is started in display blocks in a state in which the activated payline L is not set.

Next, at step S45, the main CPU41 judges whether or not the scatter prize has been established. In a case where the main CPU41 judges that the scatter prize has been established (S45: YES), the routine proceeds to step S46 at which coin payout is executed. In a case where it is judged that the scatter prize is established (S45: NO), the routine proceeds to step S47. A description of processing operation at step S45 is omitted hereinafter, since it is substantially identical to that at step S17 shown in FIG. 7.

As shown in FIG. 14B, in the future game, it is judged how many trigger symbols for the scatter prize, of the same type, have been displayed in a stopped state in any of the display blocks 28 without considering whether or not they are on the activated payline. In FIG. 14B, five “SUN” symbols are arranged, and thus, the scatter prize of FIG. 8 is established, and then, a predetermined number of coins are paid out in accordance with the five “SUN” symbols.

Next, at step S47, the main CPU41 reads game number T of the future game stored in the RAM43, and then, subtracts the value of the read game number T by 1. Then, the main CPU41 stores the game number T after subtracted again in the RAM43.

Next, at step S48, the main CPU41 judges whether or not the game number T of the future game has reached the number of times determined at step S42. Specifically, the main CPU41 makes determination in accordance with whether or not the game number T stored in the RAM43 is set to 0 (S48: NO). Then, in a case where the game number T is not set to 0 (S48: NO), i.e., in a case where the number of times in executing the future game fails to reach the game number determined at step S42, the main CPU41 reverts to step S43, and then, repeats the processing at the steps S43 to S48 mentioned above. On the other hand, in a case where it is judged that the game number of the future game is set to 0 (S48: YES), i.e., in a case where it is judged that the number of times determined at step S42 has been reached, the main CPU terminates this subroutine.

In the slot machine 10 and the playing method thereof, according to the embodiment mentioned above, if a game is started by BET number input from the BET button 26 or 27, the BET number input from the BET button 26 or 27 is counted, and then, based upon the counted BET number, “n” paylines (n=1) are determined from among the plurality of paylines L1 to L3. Then, the determined “n” paylines are activated in display blocks 28 of the lower image display panel 16. When plural types of symbols, which were arranged in display blocks 28 of the lower image display panel 16, are automatically rearranged, the number of trigger symbols for the special prize, which were rearranged on the “n” activated paylines L, is counted. Then, the number of trigger symbols for the scatter prize, which were rearranged in the display blocks 28, is counted. As the result of counting, in a case where it is judged that three or more trigger symbols for the scatter prize are rearranged in any of the display blocks 28, the scatter prize of FIG. 8 is established, and then, a predetermined number of coins are paid out according to the types and number of counted symbols and the BET number. In addition, in a case where it is judged three or more trigger symbols serving as the special prize are rearranged on one activated payline L, the special prize of FIG. 5 is established, and then, the special prize (such as a future game) corresponding to the number of counted symbols is awarded.

In the slot machine 10 and playing method thereof, according to the present invention, a payment and the special prize are determined depending upon “n” activated paylines and the types and number of scatter symbols. Thus, the players are allowed to raise the feeling of expectation not only for the displayed number of scatter symbols, but also for the payline on which scatter symbols are displayed. In this manner, a variety of enjoyments can be provided to the players.

In the slot machine 10 and playing method thereof, according to the present invention, the positions and line numbers of activated paylines are set in response to the input of the BET number. Thus, the present invention can provide to players two types of games, i.e., a base game in which the BET number input is required and the activated payline is set; and a future game in which no BET number input is required and no activated payline is set.

In addition, “n” activated paylines are determined and set in display blocks 28 prior to starting scrolling of symbols. After that, the special prize is awarded corresponding to the number of scatter symbols displayed in a stopped state in the display blocks 28 in which “n” activated payline are set. In this manner, the players are allowed to enjoy games over multiple stages between a state at which “n” activated paylines are set and a stage at which symbols are displayed in a stopped state.

Further, the positions and line numbers of the paylines are changed according to the BET number input from the BET button 26 or 27. Thus, the players can arbitrarily set the positions and line numbers of the paylines in games.

Furthermore, the types of prizes are different depending upon how many specific scatter symbols are rearranged on the activated payline. In this manner, a variety of prizes can be awarded to the players.

While the embodiment according to the present invention has been described, the description presents only some of the specific examples and is not intended to limit the present invention in any way and specific constructions of each means and the like can be properly changed in terms of design. Besides, the effects described in the embodiment of the present invention are only the most preferable effects generated from the present invention and the effects to be caused by the present invention is not limitative thereto.

The more important features of the invention have thus been outlined, rather broadly, in order that the aforementioned detailed description thereof may be better understood, and in order that the present contribution to the art may be better appreciated. There are, of course, additional features of the invention that were described above and which formed the subject matter of the claims appended hereto. In this respect, upon explaining at least one embodiment of the invention in detail, it is to be understood that the invention is not limitative in its application to the details of construction and to the arrangements of the components set forth in the aforementioned description or illustrated in the drawings. According to the invention, other embodiments can be variously practiced and carried out as well. Also, it is to be understood that the phraseology and terminology employed herein are merely intended for the descriptive purpose and should not be regarded as limiting. As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These matters together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matters in which there are illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art. A procedure is here, and generally, conceived to be a self-consistent sequence of steps leading to a desired result. These steps require physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities. Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices. The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general-purpose machines may be used with programs written in accordance with the teachings herein, or it may prove more convenient to construct more specialized apparatus to perform the required method steps. The required structure for a variety of these machines will appear from the description given.

What is claimed is:

1. A slot machine, comprising:
a display device on which plural types of symbols are arranged and a plurality of paylines can be set;
at least one input device; and
a controller,
the controller being configured to:
(i) determine “n” paylines (n=1) from among the plurality of paylines, based upon input information input from the input device;
(ii) set on the display device said “n” paylines determined in the itemized (i);
(iii) automatically rearrange the plural types of symbols arranged on the display device;
(iv) count the number of symbols of a same type, the symbols being rearranged on said “n” paylines set in the itemized (ii); and
(v) award prizes corresponding to the number of symbols counted in the itemized (iv).

2. The slot machine according to claim 1, wherein:
the input device is for inputting a BET number; and
the controller, in the itemized (i), counts the BET number input from the input device, and then, determines “n” paylines from among the plurality of paylines.

3. The slot machine according to claim 1, wherein:
when input information is input from the input device, the controller, in the itemized (i), determines “n” paylines from among the plurality of paylines, based upon the input information input from the input device.

4. The slot machine according to claim 1, wherein:
the prizes of the itemized (v) include a first prize for executing a free game by a predetermined number of times and a second prize with high payment to be accumulatively added; and
the controller, in the itemized (v), awards the first prize if the number of symbols counted in the itemized (iv) is a first number, awards the second prize if it is a second number, and awards both of the first and second prizes if it is a third number.

5. The slot machine according to claim 1, wherein:
the controller further includes paying out gaming media corresponding to the number of symbols of a same type, the symbols being rearranged on said “n” paylines.

6. The slot machine according to claim 1, wherein:
the controller further includes paying out gaming media corresponding to the number of symbols, the symbols being rearranged in all regions of the display device including an area on said “n” paylines.

7. The slot machine according to claim 1, wherein:
the input device is for inputting a BET number; and
if a BET number is input from the input device, the controller counts the input BET number, and accumulatively adds to the prizes of the itemized (v) gaming values that are based upon the counted BET number.

8. The slot machine according to claim 1, wherein:
the prizes of the itemized (v) are payout of gaming media corresponding to the number of symbols of a same type; and
the controller, in the itemized (v), pays out the gaming media corresponding to the number of symbols counted in the itemized (iv).

9. A slot machine, comprising:
a display device having a plurality of compartmented regions arranged in a matrix, plural types of symbols being disposed in each of the compartmented regions;
at least one input device; and
a controller,
the controller being configured to:
(i) determine a plurality of activated regions from among the plurality of compartmented regions, based upon input information input from the input device;
(ii) set on the display device said plurality of activated regions determined in the itemized (i);
(iii) automatically rearrange plural types of symbols in the plurality of compartmented regions;
(iv) count the number of symbols of a same type, the symbols being rearranged in said plurality of activated regions set in the itemized (ii); and
(v) award prizes corresponding to the number of symbols counted in the itemized (iv).

10. The slot machine according to claim 9, wherein:
the input device is for inputting a BET number; and
the controller, in the itemized (i), counts the BET number input from the input device, and then, determines the plurality of activated regions from among the plurality of compartmented regions.

11. The slot machine according to claim 9, wherein:
the controller further includes paying out gaming media corresponding to the number of symbols of a same type, the symbols being rearranged on the plurality of activated regions.

12. The slot machine according to claim 9, wherein:
the controller further includes paying out gaming media corresponding to the number of symbols of a same type, the symbols being rearranged in all regions of the display device including the plurality of activated region.

13. A slot machine playing method, comprising the steps of:
(i) determining “n” paylines (n=1) from among the plurality of paylines that can be set on a display device, based upon input information input from the input device;
(ii) setting on the display device said “n” paylines determined at the step (i);
(iii) automatically rearranging the plural types of symbols arranged on the display device;
(iv) counting the number of symbols of a same type, the symbols being rearranged on said “n” paylines set at the step (ii); and
(v) awarding prizes corresponding to the number of symbols counted at the step (iv).

14. The slot machine playing method according to claim 13, wherein:
a BET number is input from the input device; and
the BET number input from the input device is counted at the step (i), and “n” paylines are determined from among the plurality of paylines, based upon the counted BET number.

15. The slot machine playing method according to claim 13, wherein:
when input information is input from the input device, “n” paylines are determined from among the plurality of paylines, based upon the input information input from the input device.

16. The slot machine playing method according to claim 13, wherein:
at the step (v), a first prize is awarded for executing a free game by a predetermined number of times if the number of symbols counted at the step (iv) is a first number; a second prize with high payment is awarded to be accumulatively added if it is a second number; and both of the first and second prizes are awarded if it is a third number.

17. The slot machine playing method according to claim 13, further comprising the step of paying out gaming media corresponding to the number of symbols of a same type, the symbols being rearranged on said “n” paylines.

18. The slot machine playing method according to claim 13, further comprising the step of paying out gaming media corresponding to the number of symbols of a same type, the symbols being rearranged in all regions of the display device including a region on said “n” paylines.

19. The slot machine playing method according to claim 13, wherein a BET number is input from the input device, further comprising the steps of: if a BET number is input from the input device, counting the input BET number; and accumulatively adding to the prizes of the step (v) the gaming values that are based upon the counted BET number.

20. The slot machine playing method according to claim 13, wherein:
the prizes of the step (v) are payout of gaming media corresponding to the number of symbols of a same type, and gaming media corresponding to the number of symbols counted at the step (iv) are paid out at the step (v).
